(19) United States
(12) Patent Application Publication
(10) Pub. No.: US 2024/0360906 A1
(43) Pub. Date: Oct. 31, 2024

(54) GUIDE TRACK ALIGNMENT METHOD AND SYSTEM FOR A GATE VALVE

(71) Applicant: Mueller International, LLC, Atlanta, GA (US)

(72) Inventors: Conner Scott Holmes, Chattanooga, TN (US); Eric Joseph Manternach, Chattanooga, TN (US); Paul S. Gifford, Chattanooga, TN (US); Matthew Thomas Sutterfield, Signal Mountain, TN (US); Walter Pierce Wojick, Lookout Mountain, GA (US)

(21) Appl. No.: 18/140,552

(22) Filed: Apr. 27, 2023

(51) Int. Cl. F16K 3/316; F16K 27/04

(52) U.S. Cl. CPC F16K 3/316; F16K 27/044; F16K 3/0281

(57) ABSTRACT

A valve and a method of manufacturing the valve with an adjustable guide assembly is disclosed. The valve comprises a valve body, a gate, and a guide assembly. The valve body defines a valve port and a guide channel. The gate is configured to slide along the guide channel in the valve body between open and closed configurations. The guide assembly comprises a track and a seat. The track comprises an adjustment plate coupled to the track. The adjustment plate of the track is mounted in the guide channel to seal a portion of the gate slideably captured in the guide channel. The seat engages and seals the gate in the closed configuration.

### TECHNICAL FIELD

This disclosure relates to valves. More specifically, this disclosure relates to a guide track alignment system to guide a gate valve into a valve seat.

### BACKGROUND

Gate valves can be used in fluid utility lines. A gate valve comprises a gate that is located within the valve and is slidably moved into or out of a valve port to open or close the valve. This movement either permits or obstructs fluid passage through a valve port from an inlet to an outlet of the valve. A threaded stem is rotated to move the gate out of or into the flow stream of the valve port and to open or close the valve. When the gate is moved into the flow stream, the edges of the gate form a fluid-tight seal in a seat to prevent fluid from traversing the valve. In large water utility lines, significant pressures can be generated.

These pressures can increase the torque or force required to open and/or close the valve and can cause fluid leakage through the seal formed at the seat and/or edges of the gate.

### SUMMARY

It is to be understood that this summary is not an extensive overview of the disclosure. This summary is exemplary and not restrictive, and it is intended to neither identify key or critical elements of the disclosure nor delineate the scope thereof. The sole purpose of this summary is to explain and exemplify certain concepts of the disclosure as an introduction to the following complete and extensive detailed description.

In one aspect, disclosed is a valve comprising a valve body, a gate, and a guide assembly. The valve body defines a valve port and a guide channel. The gate is configured to slide along the guide channel in the valve body between an open configuration and a closed configuration. The guide assembly comprises a track mounted in the guide channel and configured to seal a portion of the gate in the guide channel. The guide assembly comprises an adjustment plate coupled to the track. A seat engages and seals with the gate in the closed configuration.

In a further aspect, disclosed is a method of manufacturing a valve. The method comprises fitting a guide assembly comprising a track within a guide channel of a valve body. The track is installed within the guide channel and configured to support a gate. An adjustment plate is coupled to the track to adjust the thickness in a transverse section of the track of the guide assembly within the guide channel.

Various implementations described in the present disclosure may comprise additional systems, methods, features, and advantages, which may not necessarily be expressly disclosed herein but will be apparent to one of ordinary skill in the art upon examination of the following detailed description and accompanying drawings. It is intended that all such systems, methods, features, and advantages be included within the present disclosure and protected by the accompanying claims. The features and advantages of such implementations may be realized and obtained by means of the systems, methods, features particularly pointed out in the appended claims. These and other features will become more fully apparent from the following description and appended claims or may be learned by the practice of such exemplary implementations as set forth hereinafter.

### BRIEF DESCRIPTION OF THE DRAWINGS

The accompanying drawings, which are incorporated in and constitute a part of this specification, illustrate several aspects of the disclosure and together with the description, serve to explain various principles of the disclosure. The drawings are not necessarily drawn to scale. Corresponding features and components throughout the figures may be designated by matching reference characters for the sake of consistency and clarity.

FIG. 1 is a perspective view of a gate valve showing a gate in an open position in accordance with one aspect of the current disclosure.

FIG. 2 is a perspective view of the gate valve of FIG. 1, showing the gate in a closed position.

FIG. 3 is a cross-sectional perspective view of the gate valve in the open position taken along line 3-3 of FIG. 1.

FIG. 4 is a cross-sectional perspective view of the gate valve in the closed position taken along line 4-4 of FIG. 2.

FIG. 5 is a cross-sectional orthogonal view of a valve body of the gate valve with the gate removed to show a guide assembly and taken along line 3-3 of FIG. 1.

FIG. 6 is a side perspective cross-sectional view taken along line 6-6 of FIG. 1, showing the guide assembly within a guide channel of the gate valve.

FIG. 7 is a top perspective view of the guide assembly installed within the guide channel of the gate valve of FIG. 1.

FIG. 8 is an exploded side perspective view of the guide assembly.

FIG. 9 is an inner perspective view of the guide assembly installed within the guide channel.

FIG. 10 is a perspective cross-section view of the guide assembly showing connections between an adjustment plate, a base plate, and a track.

FIG. 11 is a top inner perspective view of the guide assembly within the guide channel, with the gate comprising a cap installed within the guide assembly.

FIG. 12 is a side perspective view of the gate coupled to the cap.

FIG. 13 shows a vertical gate coupled to a stem in the open position, according to another example aspect of the disclosure.

FIG. 14 shows the vertical gate of FIG. 13 in the closed position.

FIG. 15 shows a horizontal gate coupled to the stem in the open position, according to another example aspect of the disclosure.

FIG. 16 shows the horizontal gate of FIG. 15 in the closed position.

### DETAILED DESCRIPTION

The present disclosure can be understood more readily by reference to the following detailed description, examples, drawings, and claims, and their previous and following description. However, before the present devices, systems, and/or methods are disclosed and described, it is to be understood that this disclosure is not limited to the specific devices, systems, and/or methods disclosed unless otherwise specified, as such can, of course, vary. It is also to be understood that the terminology used herein is for the purpose of describing particular aspects only and is not intended to be limiting.

Fluid utility lines can use a gate valve where a gate is located and slidably translated within the valve to move into or out of a valve port and open or close the valve. When the gate is moved into a flow stream through the valve port, a guide can be used to capture the gate against the pressure of fluid flowing through a valve port. When fully closed, gate edges of the gate form a fluid-tight seal in a seat to prevent fluid from traversing the valve. However, when the gate is partially open or partially closed, the fluid flowing through the valve port can increase the torque or force needed to open or close the gate within the valve. Large water utility lines, e.g., of a 50-70-inch diameter pipe, can generate significant pressure as the gate is introduced and moved through the fluid flow. This pressure can generate a normal force on the gate that can increase the friction and/or increase the torque needed to open and/or close the valve.

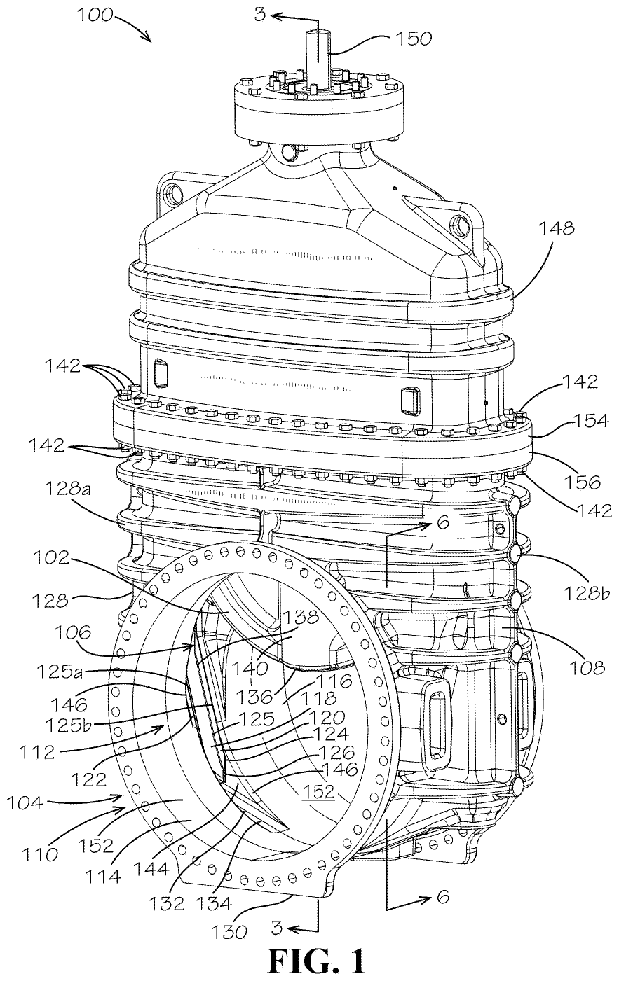

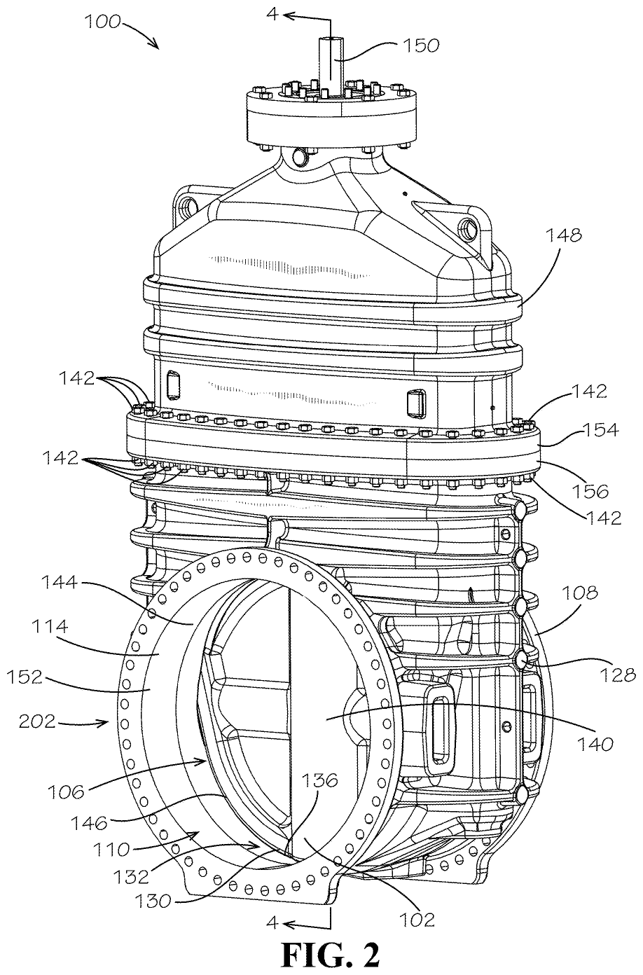

FIG. 1 illustrates a gate valve or other valve 100 comprising a gate 102 in the open position or open configuration 104. FIG. 2 shows the valve 100 with the gate 102 translated into a closed position or closed configuration 202 to obstruct fluid flow. The description of each valve herein applies to valve 100, and reference numbers for valve 100 may be used in reference to any valve in FIGS. 1-11.

Gate 102 is configured to slide along (e.g., translate back and forth along) a guide channel 106 between the open configuration 104 (FIG. 1) and the closed configuration 202 (FIG. 2). Valve 100 comprises a valve body 108 defining a valve port 110 and the guide channel 106. The valve port 110 comprises a flow channel 112 that permits fluid to flow through the valve port 110 in the open configuration 104. The flow channel 112 extends through the valve body 108 of valve 100. When the gate 102 is in the open configuration 104 the flow channel 112 is open between an inlet 114 and an outlet 116. That is, when the gate 102 is in the open configuration 104 fluid can flow through the valve port 110 from the inlet 114 to the outlet 116. Similarly, when the gate 102 is in the closed configuration 202, the flow channel 112 is closed between the inlet 114 and the outlet 116 and sealed to obstruct or prevent fluid from flowing through the flow channel 112.

Valve 100 comprises gate 102 installed within a guide assembly 118. Guide assembly 118 comprises a track 120, a barrier 122, and a cured resin or adhesive 124 within a gap 126 defined between the guide channel 106 of the valve body 108 and the track 120 of the guide assembly 118. In various aspects, the width of the gap 126 can be between about % inches and % inches. In a specific example aspect, the gap 126 can have a width between the guide assembly 118 and the guide channel 106 of approximately 5/16 inches. In other aspects, the width of the gap 126 can be less than % inches or more than % inches, or any width as desired.

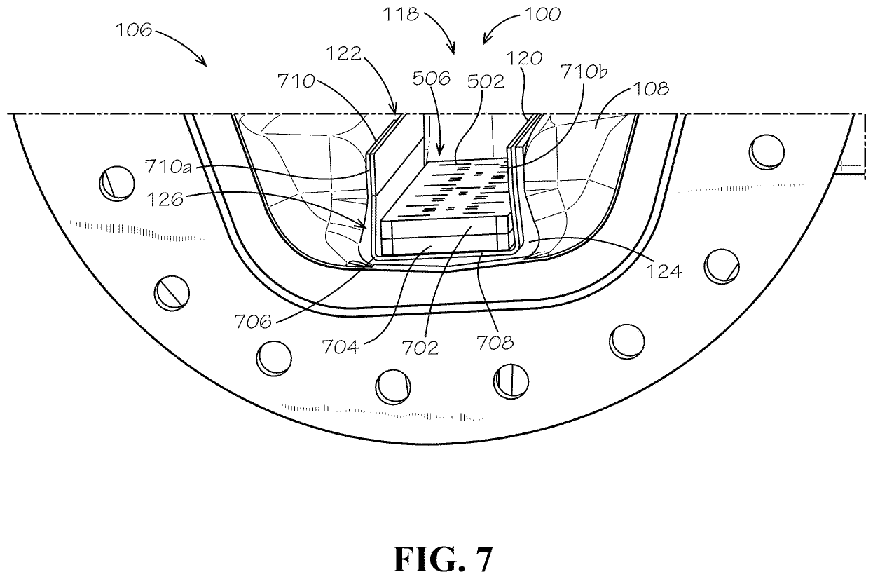

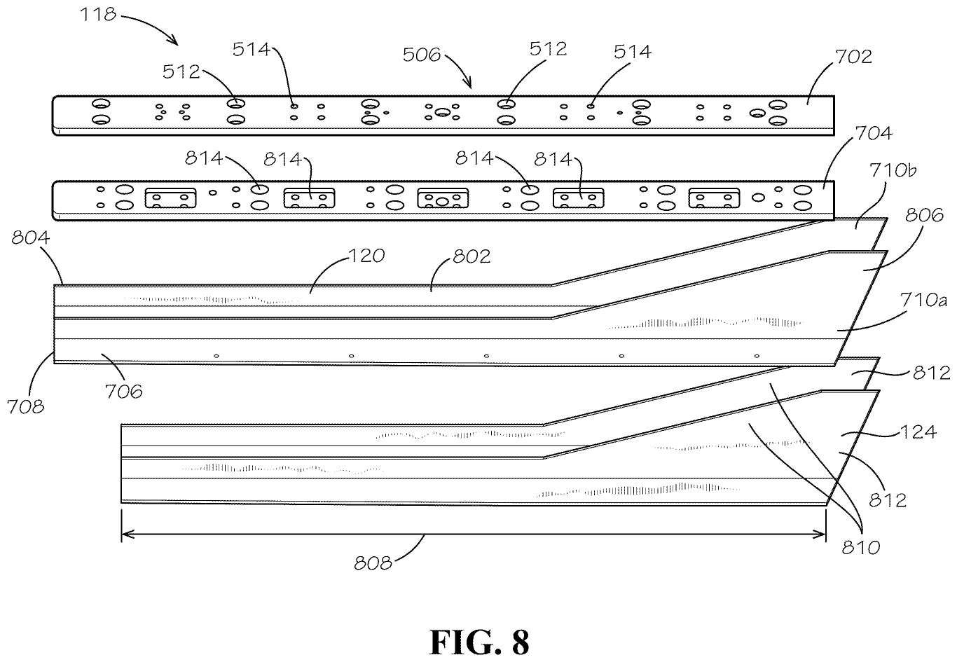

In some aspects, guide assembly 118 can further comprise an adjustment plate 702 and/or a base plate 704 (see FIGS. 7 and 8) installed within the track 120. The track 120 can mount within the guide channel 106 of the valve body 108 and form the gap 126. The gap 126 can facilitate adjustment of the track 120 and/or alignment of the track 120 relative to the gate 102 to facilitate smooth translation of the gate 102 through the guide assembly 118. Proper alignment of the gate 102 within the track 120 can also reduce frictional resistance on the gate 102 as it translates through the guide assembly 118 between the open configuration 104 and the closed configuration 202.

Guide assembly 118 can adjustably be installed within the guide channel 106 of the valve body 108 with the barrier 122 used to cover and facilitate filling the gap 126. Once the barrier 122 is in place, the liquid or uncured adhesive 124 can be inserted and/or injected into the gap 126. Once the adhesive 124 is properly inserted into the gap 126 and captured by the barrier 122, the adhesive 124 can be cured. The cured adhesive 124 within the gap 126 can structurally support and/or create a fluid-tight seal with the valve body 108.

Each side 128a and/or 128b can define a guide channel 106, such that valve 100 can have a valve body 108 comprising a guide channel 106 on an inner surface 144 of either or both sides 128a,b. For example, the guide channels 106 can extend along the inner surface 144 of both opposed lateral sides 128a,b (e.g., along vertical sides) of the valve body 108 and can further extend across a transverse side 130 that extends between the lateral sides 128a,b (e.g., along a horizontal bottom of the valve 100). In some aspects, the guide channels 106 on either side 128a,b can extend across the base 134 and/or can be connected to each other across the base 134. In the aspect shown, the base 134 separates the two guide channels 106 on the inner surface 144 of either side 128a,b.

The transverse side 130 can comprise a base seat 132 that forms a fluid-tight seal along a base 134 of the valve body 108. Valve 100 can be installed vertically, horizontally, or in an angled configuration, such that sides 128 and/or transverse side 130 can be oriented along the horizontal, vertical, or another axis. However, the lateral sides 128 (e.g., in a vertical/horizontal orientation) are generally oriented to be perpendicular to the transverse side 130 (e.g., oriented in the horizontal/vertical orientation, respectively).

Guide assembly 118 can include a pair of opposed flanges 125, such as a first flange 125a and a second flange 125b. The opposed flanges 125 extend in a direction that is substantially perpendicular to the flow channel 112. That is, the opposed flanges 125 serve to capture a portion of gate 102 and secure the gate 102 in the guide channel 106 of the valve body 108 within the opposed flanges 125a,b.

Each lateral side 128a,b can comprise guide assembly 118 configured to support the gate 102 as it moves between the open configuration 104 and the closed configuration 202. The transverse side 130 can seal with a base edge 136 of the gate 102 within the valve body 108 in the closed configuration 202. The base seat 132 can be installed or defined in the base 134 of the valve body 108 and/or within the guide channel 106, extending along the base 134 of the valve body 108. For example, the base seat 132 can be a portion of the transverse side 130 that engages the gate 102, (e.g., a lower edge of gate 102). The base seat 132 and/or guide assembly 118 can be configured to receive the gate 102 in the closed configuration 202 and obstruct fluid flow through the valve port 110 by forming a fluid-tight seal.

The guide assembly 118 can comprise the track 120 installed within the guide channel 106 of the valve body 108 and aligned within the gap 126. The barrier 122 can cover the gap 126 to prevent uncured adhesive 124 from flowing out of the gap 126 during the curing process. The adjustment of track 120 facilitates the translation or movement of the gate 102 between the open configuration 104 and the closed configuration 202 and vice versa. The track 120 can at least partially define the gap 126 between the guide assembly 118 and the track 120. Specifically, gap 126 is defined between the guide channel 106 of the valve body 108 and the track 120 of the guide assembly 118. In some aspects, the barrier 122, which can be a lattice mesh in the present aspect, can be disposed within the gap 126. The adhesive 124, such as an epoxy or a resin, can be cured on the barrier 122 to form a temporary boundary 138 that retains additional liquid adhesive 124 in the gap 126 and captured between the temporary boundary 138, the guide assembly 118, and the track 120. Once the liquid adhesive 124 is installed (e.g., injected into gap 126), the adhesive 124 can be cured to form a cured adhesive 124. In the closed configuration 202, the gate 102 is sealed within the gap 126. The barrier 122 can be coated with adhesive 124 along its exterior and cured to structurally support and/or seal the guide assembly 118.

In one aspect, the gate valve 100 that can comprise gate 102 slidably coupled to guide assembly 118 of the valve 100 along the adjustable track 120 is disclosed with associated methods, systems, devices, and various apparatuses. The gate 102 can be a solid wedge or can be a composite part or portion comprising an encapsulated disc or plate 140 encapsulated in rubber and coupled with a central shaft (shown as stem 150). In one aspect, the translation or movement of the gate 102 through or along the guide assembly 118 can comprise adjustment and/or specific modification by creating the temporary boundary 138 with the barrier 122 and/or adhesive 124 that is later backfilled with uncured adhesive 124. The uncured adhesive 124 can be captured by the temporary boundary 138 and cured to securely couple the track 120 of the guide assembly 118 to the guide channel 106. This method can accommodate field installations and/or modifications and adjustments to the track alignment in the field to adjust for the specific configuration of the installation. In some aspects, modifications to adjustment plate 702 (FIG. 7) can improve the track alignment. The uncured adhesive 124, can adjust to fill gap 126 before curing. Using adhesive 124 to fill gap 126 ensures that gate 102 properly fits within, supports, and/or seals against the track 120 and guide assembly 118 of valve 100. Moreover, as will be discussed in detail below, the adhesive 124 can be a composite comprising two or more components. For example, and without limitation or disclaimer, the first component of the malleable adhesive 124 can comprise a putty, such as a plumber's putty, and the second component of the adhesive 124 can comprise a cured epoxy. The putty can provide sealing attributes, and the cured epoxy can provide structural rigidity. The structural integrity of the cured adhesive 124 can support the seal of valve 100. The epoxy can be cured to provide structural rigidity. The application of the putty can create a fluid-tight seal and may be removed and/or stay within valve 100 following application and/or curing of the epoxy. Putty and/or adhesive 124 can support the guide assembly 118 and the gate 120 to reduce torque and reduces rubber wear on the gate to provide a fluid-tight seal.

The guide assembly 118 can comprise a pair of opposed guide assemblies 118 and/or tracks 120 on either side of the valve body 108 along an inner surface 144 of the valve body 108. Coupling each of the pair of opposed guide assemblies 118 to the valve body 108 can facilitate adjustment of each guide assembly 118 relative to gate 102 to account for sliding movements or translations of the gate 102 through the guide assembly 118. In some aspects, epoxy or adhesive 124 can couple the opposed guide assemblies 118 to the valve body 108. When adhesive 124 is used, the uncured adhesive 124 in the gap 126 of each guide assembly 118 should be retained in the correct location relative to the valve body 108 during the curing process. Proper retention of the curing adhesive 124 ensures proper placement of the guide assembly 118 (e.g., relative the gate 102, valve body 108, and/or guide channel 106) within the guide channel 106 to support the translation movement of the gate 102 through the guide assembly 118. The proper retention of the adhesive 124 during curing can affect the strength of the joint (FIG. 10), the fluid-tight seal, and/or the proper support that the track 120 provides to the gate 102 when translating, e.g., between an open configuration 104 and a closed configuration 202 (FIG. 2). Accordingly, the barrier 122 serves to retain the adhesive 124 during the curing process to ensure a proper connection that provides adequate support to the gate 102 and the guide assembly 118 within the guide channel 106.

The uncured adhesive 124 can be a liquid with a viscosity (e.g., inviscid, Newtonian, or non-Newtonian, resistance to an applied shear force). The adhesive 124 can cure into a solid that can support and/or resist shear forces and/or pressure loads. The barrier 122 can help maintain the uncured liquid adhesive 124 within the gap 126 and along a perimeter 146 of the valve body 108 within the guide channel 106 during the curing process. Thus, the adhesive 124 can be molded, formed, cured, and then seal any variations in the gap 126. For example, by curing the lattice mesh barrier 122 before the uncured adhesive 124 is poured or injected into the gap 126 behind the track 120, the lattice mesh barrier 122 can serve to retain the liquid uncured adhesive 124 in the desired form of the custom seal in the gap 126 between the guide assembly 118 and the guide channel 106. The barrier 122 can retain the uncured adhesive 124 adjacent to the guide assembly 118 within the guide channel 106 while the adhesive 124 is cured to fix and seal the track 120 in the proper location and orientation within the guide channel 106 to ensure that the gate 102 properly seals the flow channel 112. The adhesive 124 can enhance the installation and adjustment of the track 120 within the guide channel 106 and can facilitate the proper sealing and alignment of the gate 102 within the guide channel 106.

FIGS. 1 and 2 show that a pressurized sealed bonnet 148 can capture the stem 150 coupled to the gate 102. In the current aspect, the bonnet 148 can be coupled to the valve body 108 by a plurality of fasteners 142 coupling a mounting flange 154 of the bonnet 148 to a mounting flange 156 of the valve body 108. The pressurize sealed bonnet 148 can be configured to maintain a fluid-tight seal between the gate 102, the valve body 108, and/or the bonnet 148 to protect the stem 150 even when the valve body 108 and/or gate 102 are subjected to high pressure, such as when the gate 102 is in the closed configuration 202, as shown in FIG. 2.

A wettable surface 152 of the valve port 110 can be defined between the inlet 114 and the outlet 116. The wettable surface 152 can be any part of the valve port 110 (comprising, e.g., the guide channel 106 within the valve body 108 and/or the guide assembly 118) that is wetted by a fluid, in either the open configuration 104 or the closed configuration 202. For example, one difference between the open configuration 104 and the closed configuration 202 is that wettable surfaces 152 of the outlet 116 are wetted in the open configuration 104 the fluid traversing the fluid channel 112, but the wettable surfaces 152 of the outlet 116 are not wetted in the closed configuration 202. In both the open configuration 104 and the closed configuration, the inlet 114 has wettable surfaces 152 that are wetting when valve 100 is in operational service.

In various aspects, the barrier 122 can be layered with the uncured adhesive 124 to prevent the barrier 122 from protruding into the wettable surface 152 of the valve port 110. For example, the barrier 122 can be linen or lattice. In a specific example, the barrier 122 can be a stainless-steel wire mesh lattice that is coated or painted with uncured adhesive 124. At each the inlet 114 and the outlet 116 sides, the barrier 122 covers the gap 126 and is cured. The wettable surface 152 of the barrier 122 in the gap 126 (e.g., at both the inlet 114 and the outlet 116) that extend into the fluid flow channel 112 can be painted and/or covered with uncured adhesive 124, so that the cured adhesive protects the barrier 122 (e.g., a wire lattice mesh) from corrosion by the fluid (e.g., water) in the valve port 110.

FIG. 2 shows valve 100 with gate 102 in the closed configuration 202. Concerning FIGS. 1 and 2, the temporary boundary 138 can be formed by inserting barrier 122 into gap 126 and painting adhesive 124 on or over the barrier 122 and allowing the adhesive 124 to cure. Once adhesive 124 is cured it forms the temporary boundary 138. Then, more uncured liquid adhesive 124 can be added (e.g., injected or inserted) into the gap 126 to fill the space between the guide assembly 118, the barrier 122, and the guide channel 106 of the valve body 108. The adhesive 124 can be an epoxy or resin and can be cured to couple the guide channel 106 to the guide assembly 118. The uncured adhesive 124 can be adjusted to ensure a proper fit of the gate 102 within the guide assembly 118. This can also reduce friction forces generated on the gate 102 when it is moved from the open configuration 104 to the closed configuration 202, and vice versa. For example, the uncured adhesive 124 can adjust to variations in the construction of the valve body 108, installation-specific requirements, and/or the installation of the gate 102 and/or track 120 within the guide assembly 118.

The adhesive 124 can be epoxy that can be painted onto or applied to the barrier 122, which can be a wire mesh. The adhesive 124 can be cured to form the temporary boundary 138 and provide a barrier to capture the second stage of liquid adhesive 124 or epoxy introduced into the gap 126 between the guide assembly 118, the temporary boundary 138, and/or the track 120 to securely position and/or couple the track 120 to the guide assembly 118. In various aspects, track 120 can be bolted to guide assembly 118 and epoxy can fill in the gap 126. In other words, the application of the adhesive 124 can occur in two separate stages to improve the placement of the guide assembly 118 and/or track 120 and ensure the proper placement of the liquid adhesive 124 before curing. Specifically, the first stage can involve using a small amount of epoxy or adhesive 124 to prepare the track 120 and the temporary boundary 138 into an assembly that accepts the remainder of the adhesive 124 in the second stage. The adhesive 124 can be painted onto barrier 122 and then cured to form the temporary boundary 138. The adhesive 124 can be applied under positive pressure and/or vacuum pressure to draw the liquid adhesive 124 into various parts of the gap 126 and/or control the placement of the track 120 relative to the guide assembly 118.

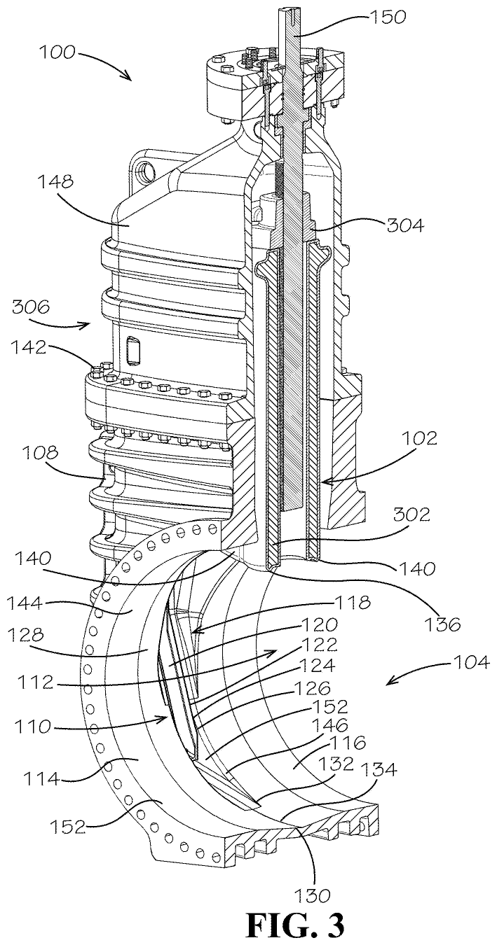

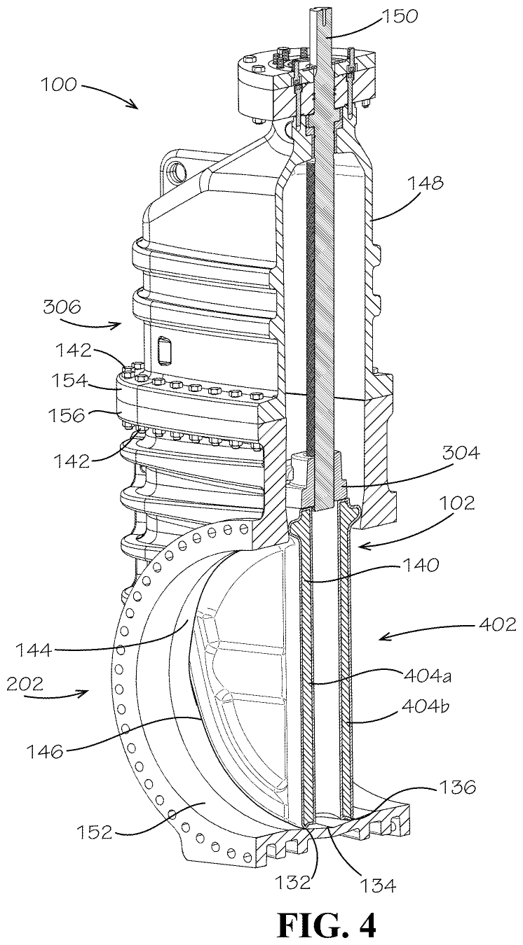

FIG. 3 is a cross-section of valve 100 in the open configuration 104 taken along line 3-3 of FIG. 1, and FIG. 4 is a cross-section view of the valve 100 in the closed configuration 202 taken along line 4-4 of FIG. 2. The fasteners 142 couple the mounting flange 154 of the bonnet 148 to the mounting flange 156 of the valve body 108. Concerning FIGS. 3 and 4, gate 102 can be an encapsulated disc comprising rigid cast iron interior plate 140 that form a disc 404 coupled to a receiver 304. In some aspects the receiver 304 can be a disc nut. The disc 404 and/or plate 140 have a rigid cast iron interior and a flexible, water-impervious outer shell (e.g., rubber, plastic, or hydrophobic material). Although gate 102 can include different materials or combinations of materials in various embodiments, some exemplary materials used in various embodiments of gate 102 can comprise steel, stainless steel, metals and metal alloys, carbon fiber reinforced plastic (CFRP), fiberglass, composites, wood, plastics, etc. The material of gate 102 should not be considered limiting. Gate 102 can be a solid wedge 302 (e.g., a cast wedge) encapsulated with rubber supported by a stem 150. The wedge 402 can comprise a disc 404 that is encapsulated in rubber. The stem 150 can couple to a pressurized seal bonnet 306 that captures stem 150. The stem 150 can extend through the bonnet 148 and be coupled to the gate 102 to facilitate transversely moving or sliding the gate 102 back and forth between the open configuration 104 and the closed configuration 202, and vice versa. In some aspects, the receiver 304 can be internally threaded and the stem 150 can be externally threaded, and rotation of the stem 150 can translate the receiver 304, and thereby the gate 102, back and forth between the open configuration 104 and the closed configuration 202. The pressurized seal bonnet 148 can support the stem 150 and/or gate 102 in high-pressure flow streams to maintain a fluid-tight seal about the guide assembly 118 and/or base seat 132.

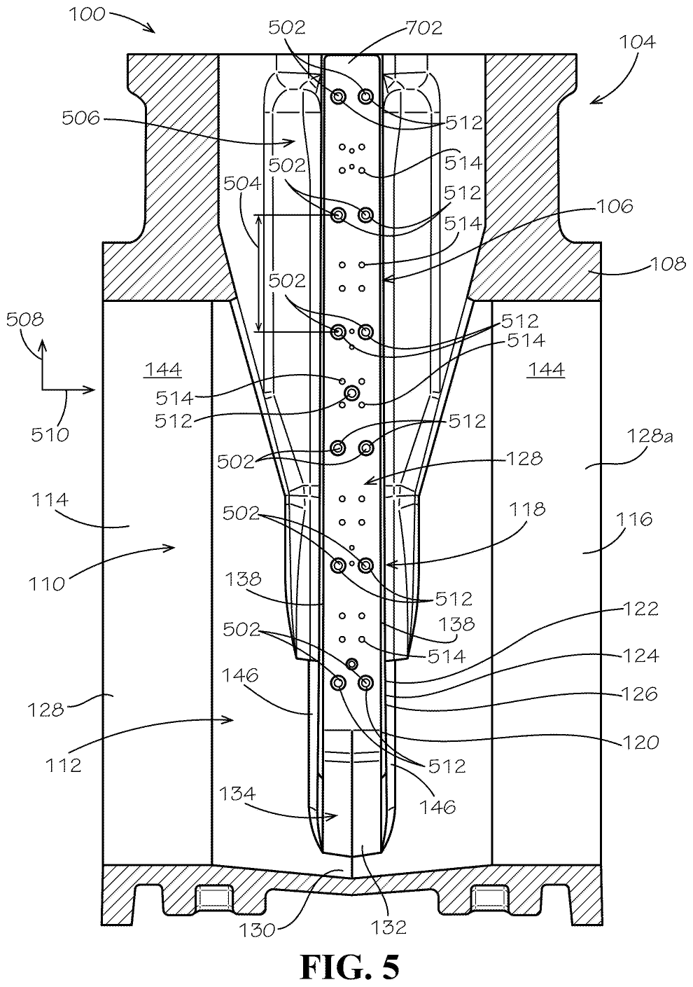

FIG. 5 is a cross-sectional orthogonal view of gate valve 100 showing gate 102 (FIG. 1) removed and taken along line 3-3 of FIG. 1. Guide tracks 120 are shown inside the lateral sides 128 of the valve body 108. A liquid epoxy, resin, and/or adhesive 124 is injected in the gap 126 between the temporary boundary 138 and cured. In some aspects, various fasteners 502 (in the present aspect illustrated as bolts) can be installed through the track 120 (and/or the adjustment plate 702 and/or base plate 704, shown in FIG. 7) to couple the guide assembly 118 to the guide channel 106 of the valve body 108. In various aspects, the fasteners 502 can be offset from one another by an offset distance 504 in a fastener pattern 506 wherein the fasteners 502 are equally spaced in a first direction 508 corresponding to the lateral sides 128 and/or a second direction 510 corresponding to a direction of fluid flow through the valve port 110 (e.g., from the inlet 114 to the outlet 116) when gate 102 is in the open configuration 104. The first direction 508 can be substantially perpendicular to the second direction 510, such that the lateral sides 128a,b of the valve body 108 are substantially perpendicular to the base 134 of the valve body 108. In aspects, the offset distance 504 can be equal, as measured between the fasteners 502 in the first direction 508, but oriented such that the fasteners 502 are not aligned in the second direction 510.

As shown in FIGS. 5 and 7-8, the guide tracks 120, adjustment plate 702, and/or base plate 704 can comprise fastener openings 512 that can have a countersunk head in the adjustment plate 702 and/or pass through the guide tracks 120, the adjustment plate 702, and/or base plate 704. That is, fastener openings 512 are configured to facilitate operator adjustment of adjustment plate 702 in the guide channel 106. Additional openings 514 can facilitate connecting adjustment plate 702 relative to base plate 704, valve body 108, and/or guide tracks 120.

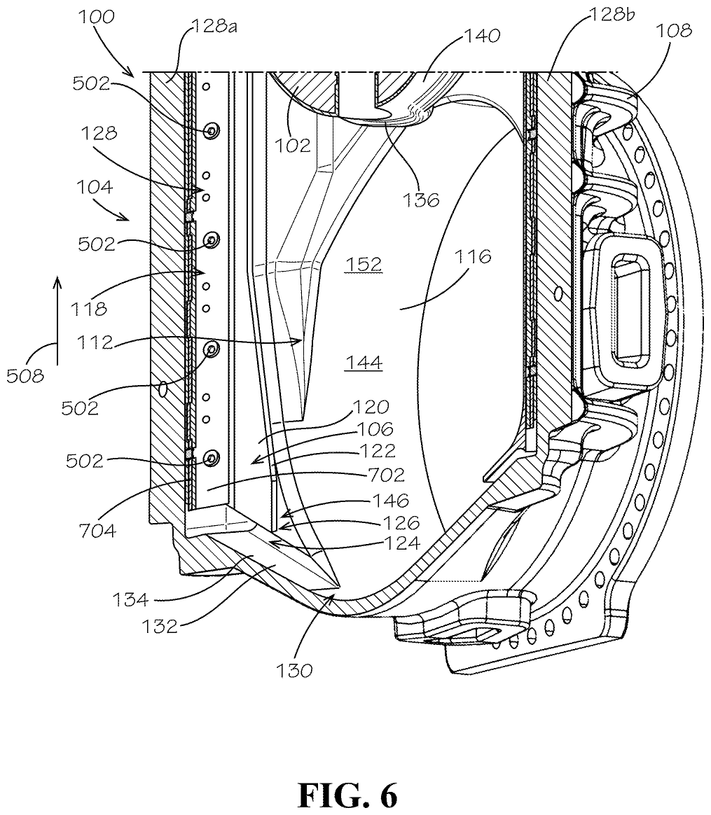

FIG. 6 is a side perspective cross-sectional view taken along line 6-6 of FIG. 1, showing the guide assembly 118 within the gate valve 100. Track 120 is installed within guide channel 106 of the valve body 108, and fasteners 502 run in the first direction 508 through the guide assembly 118 to couple the track 120, adjustment plate 702, and/or base plate 704 within the valve body 108 and facilitate adjustment of the guide assembly 118 when the gate 102 is installed within the guide assembly 118.

FIG. 7 is a top perspective view of the guide assembly 700 installed within a valve the same as or similar to valve 100 of FIG. 1. The guide assembly 700 comprises adhesive 124 cured to the track 120, which supports and partially surrounds the adjustment plate 702 and the base plate 704. The track 120 is a U-shaped rail 706 comprising a transverse section 708 interposed between two opposing sections 710a,b. When the gate 102 is in the closed configuration, a portion of the gate 102 can be captured between the two sections of the U-shaped rail 706 to contain the gate 102 within the guide channel 106. The base plate 704 and/or adjustment plate 702 can support the gate 102 as it moves or translates between the open configuration 104 and the closed configuration 202. The base plate 704 and/or the adjustment plate 702 can be modified, adjusted, and/or manufactured to ensure a fluid-tight seal is formed and the guide assembly 118 is supported in the guide channel 106. Moreover, the adhesive 124 in the gap 126 is cured to maintain the fluid-tight seal of the valve body 108. In various aspects, the gap 126 between the guide channel 106 and the track 120 is equal to or between % and % inches.

FIG. 8 is an exploded side perspective view of guide assembly 118. The guide assembly 118 comprises a hardened epoxy layer or dried adhesive 124 that couples the track 120 of the guide assembly 118 to the guide channel 106 (FIG. 1) of the valve body 108 (FIG. 1). The track 802 (the same as or similar to track 120) can have the rail 706 that can be U-shaped, C-shaped, or comprise another beam cross-sectional shape. For example, the rail 706 can have a web or transverse section 708 and a pair of opposed flanges, shown as opposing sections 710a,b, arranged in a U, C, I, H, or J cross-sectional configuration. The track 802 and/or rail 706 can have a different sized opposing sections 710a,b (e.g., flanges) on a first side 804 (e.g., near the bonnet 148, FIG. 1) than a second side 806, e.g., near the base 134 (FIG. 1) or the base seat 132 (FIG. 1) of the valve body 108. In some aspects, a transverse length of the opposing sections 710a,b at the first side 804 can be less than the transverse length of the opposing sections 710a,b at the second side 806. The increased transverse length of the opposing sections 710a,b near the base seat 132 can provide enhanced support to the gate 102 (FIG. 1) when in the closed configuration 202 (FIG. 2) to ensure a fluid-tight seal, e.g., in a large diameter pipe and/or at elevated pressures.

Guide assembly 118 can define an axial length 808 extending along the track 802 (or the adhesive 124 between the track 802 and the guide channel 106 shown in FIG. 1) in the lateral sides 128a,b (FIG. 1) of the valve body 108, e.g., extending along the first direction 508 (FIG. 5). In various aspects, the valve body 108 and/or guide assembly 118 can be configured for a diameter of the inlet 114 and or outlet 116 (FIG. 1) can be equal to or greater than 50 inches, such that the axial length 808 can be between 50 inches and 75 inches, specifically between 55 and 70 inches, and more specifically between 60 and 65 inches.

As shown the first side 804 is less than the second side 806, because the second side 806 of each track 802 comprises a tapered portion 810 that extends outward from the transverse section 708 of the track 802 at the second side 806, near the bottom of the guide channel 106. The tapered portion 810 extends outward from the transverse section 708 and inward toward the flow channel 112 to match an increasing depth of the guide channel 106 at the bottom semicircle formed at the bottom of gate 102 and/or guide channel 106. Below a diameter of gate 102 extending from a first lateral side 126a to a second lateral side 126b (FIG. 6) of valve body 108, the gate 102 slides within a guide channel 106 that is coupled to the tapered portion 801 extending into the flow channel 112 to facilitated sealing the valve body 108 with a circular gate 102. As shown, the track 802 can have a toe 812 that extends substantially downward from the tapered portion 810 to the base seat 132 on a traverse side 130 (FIG. 6).

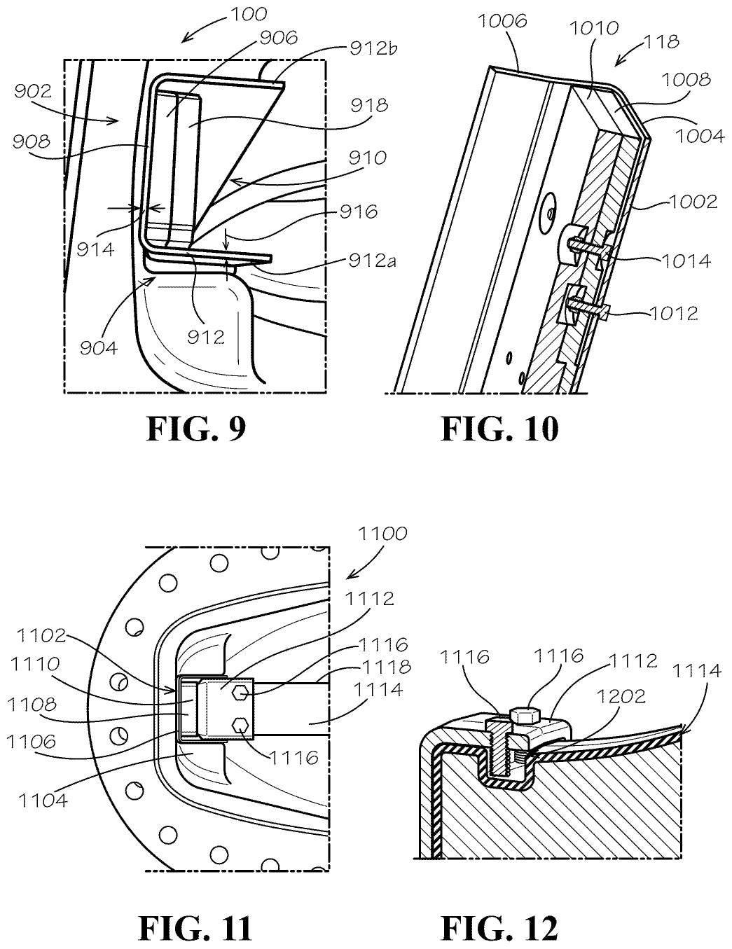

FIG. 9 shows a perspective view of a guide assembly 902 installed within a guide channel 904 of a valve 100, the same as or similar to valve 100. The guide assembly 902 can comprise a base plate 906 coupled to a web 908 of a track 910. Flanges 912, such as two opposing flanges 912a,b, of the U-shaped track 910 can at least partially capture the base plate 906 coupled to the web 908 of the track 910. In some aspects, a thickness 914 of the web 908 can be equal to or greater than a thickness 916 of the two opposing flanges 912a,b. Additional thickness (e.g., thickness 914) can be added to the web 908 through a structural design comprising a web 908 with a greater thickness than the two opposing flanges 912a,b. Similarly, additional thickness can be added by coupling the base plate 906 and/or an adjustment plate 918 to the web 908. In addition, the base plate 906 and/or the adjustment plate 918 can be coupled to the web 908 to increase the structural rigidity of the track 910 and seal the gate 102 (FIG. 1) within the track 910. That is, where the web 908 has an equal thickness to the two opposed flanges 912a,b, the structural rigidity and/or stiffness of the web 908 can be enhanced by coupling and/or attaching the base plate 906 and/or the adjustment plate 918 to the web 908 of the track 910 and thereby stiffening the web 908.

The guide assembly 902 is configured to be installed within the guide channel 904. The guide assembly 902 can be customized to adjust and/or modify the thickness 914 of the web 908 during installation and/or operation. Additional thickness of the web 908 can be customized and added through the addition of the base plate 906 and/or the adjustment plate 918. The composite web 908, base plate 906, and/or adjustment plate 918 can be adjusted to securely capture, seal, and support the gate 102 and reduce friction between the gate 102 and the track 910. The reduced friction can facilitate the use of an actuator coupled to the gate 102 to open and close valve 100. Similarly, the reduced friction can reduce maintenance and/or enhance the serviceable life of valve 100, e.g., the longevity of the gate 102, the guide channel 904, and/or the guide assembly 902.

FIG. 10 is a cross-sectional view of guide assembly 118, the same as or similar to guide assembly 118 (FIG. 1). Guide assembly 118 can comprise a track 1002 comprising a web 1004 interposed between and coupled to a pair of opposing flanges 1006. A base plate 1008 and/or an adjustment plate 1010 can be attached or coupled to the web 1004 to support the gate 102 (FIG. 1) within the track 1002 as it translates back and forth between the open configuration 104 and the closed configuration 202 (See, e.g., FIGS. 1 and 2). In some aspects, various primary fasteners 1012 can couple or connect the base plate 1008 to the web 1004 of the track 1002 and various secondary fasteners 1014 can couple or connect the adjustment plate 1010 to the base plate 1008. As illustrated in FIG. 10, primary fasteners 1012 do not extend through the adjustment plate 1010 and secondary fasteners 1014 do not extend through the track 1002. Instead, primary fasteners 1012 can extend between the web 1004 of the track 1002 and the base plate 1008. Secondary fasteners 1014 can be the same as or similar to the primary fasteners 1012, but can extend between the adjustment plate 1010 and the base plate 1008. That is, no fastener (e.g., primary fasteners 1012 or secondary fasteners 1014) extends entirely through the entire guide assembly 118 comprising the web 1004 of the track 1002, the base plate 1008, and the adjustment plate 1010.

In this way, the base plate 1008 can be independently coupled to the adjustment plate 1010 and the track 1002. In some aspects, this configuration can reduce stress on the guide assembly 118 and/or can facilitate greater adjustment of a combined effective thickness of the guide assembly 118 created by the combination of the web 1004, base plate 1008, and adjustment plate 1010 in the guide channel 106 (e.g., FIG. 1).

FIG. 11 is a top view of valve 1100 comprising a guide assembly 1102 within a guide channel 1104 of valve 1100, the same as or similar to valve 100. The guide assembly 1102 can comprise a track 1106, a base plate 1108, and an adjustment plate 1110. A guide cap or cap 1112 can be coupled to a gate 1114. FIG. 12 is an isolated side perspective view of gate 1114 coupled to the cap 1112. With reference to FIGS. 11 and 12, the gate 1114 can couple to the cap 1112 and can be installed within the track 1106 of guide assembly 1102. The cap 1112 can be coupled to the gate 1114 and can slide within track 1106 between the open configuration 104 (FIG. 1) and the closed configuration 202 (FIG. 2). In some aspects, the cap 1112 can comprise a securing bolt 1116 (shown as a pair of securing bolts 1116) that can fasten the cap 1112 to the gate 1114. The cap 1112 can extend along track 1106 and provide a fluid-tight seal between the gate 1114 and the guide assembly 1102. Similarly, the cap 1112 can couple to a seat 1118 in the closed configuration 202 to facilitate the fluid-tight seal along the base seat 132 and/or base 134 (FIG. 1) to form the fluid-tight seat 1118 of the valve 1100.

The cap 1112 may comprise a different material than the track 1106, the base plate 1108, and/or the adjustment plate 1110 and can be configured to reduce friction between the gate 1114 and the guide assembly 1102 to slidably seal the gate 1114 against the adjustment plate 1110 of the track 1106. In some aspects, cap 1112 can comprise a plurality of securing bolts 1116 fastened into or within a fastening slot 1202 of the gate 1114. The fastening slot 1202 can receive the securing bolts 1116 and securely couple the cap 1112 to the gate 1114 to reduce friction, improve wear and tear on the gate 1114, and maintain a fluid-tight seal between the gate 1114 and the track 1106 of the guide assembly 1102. In some aspects, the track 1106, the base plate 1108, and/or the adjustment plate 1110 can comprise steel (e.g., stainless steel) and the cap 1112 can comprise a non-steel alloy (e.g., bronze). In other aspects, the track 1106, the base plate 1108, the adjustment plate 1110 and/or the cap 1112 can comprise any other suitable material known in the art. In other aspects, the cap 1112 may comprise the same material as the track 1106, the base plate 1108, and/or the adjustment plate 1110.

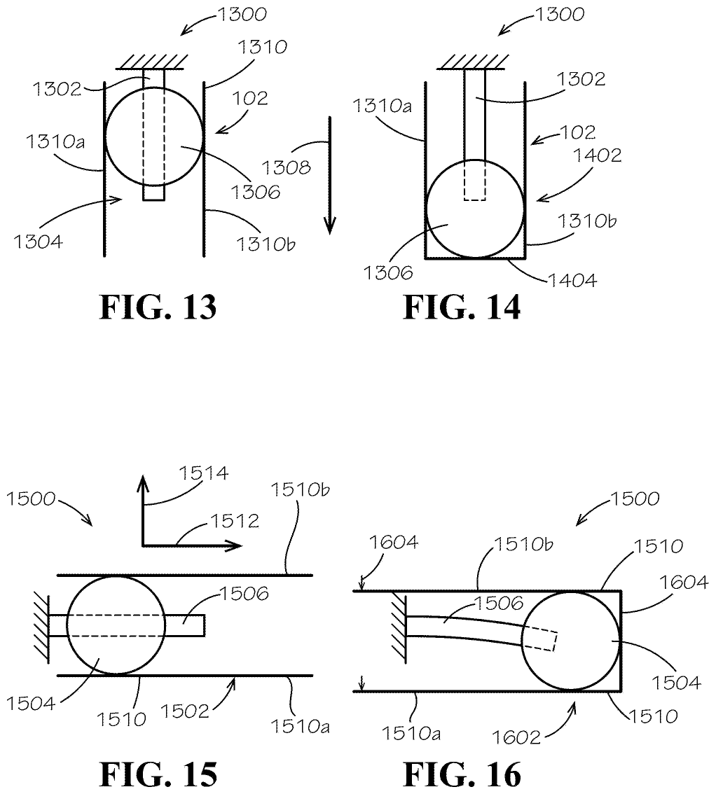

FIGS. 13 and 14 show a vertical gate valve 1300 oriented in the vertical orientation and coupled to a vertical stem 1302 in an open configuration 1304 and a closed configuration 1402, respectively. That is, FIG. 13 shows the open configuration 1304 and FIG. 14 shows the closed configuration 1402. In various aspects, vertical gate valve 1300 is the same as or similar to gate valve 100 installed in the vertical orientation.

FIG. 13 shows a disc 1306 moving in a vertical direction 1308 and coupled to vertical stem 1302 (e.g., the same as or similar to stem 150 oriented vertically to support one or more plates 140, shown in FIGS. 1-4). In the open configuration 1304 (FIG. 13), the disc 1306 can travel up the vertical stem 1302, e.g., to move the gate 102 through the tracks 120 (FIG. 1) and out of the flow channel 112 (FIG. 1). Moving from the open configuration 1304 (FIG. 13) to the closed configuration (FIG. 14), the disc 1306 can move downward along the vertical stem 1302 and can be restrained between two opposing guide assemblies 1310a,b. Guide assemblies 1310a,b can seal a vertical portion of disc 1306 and a seat 1404 at the bottom of disc 1306 seals the flow channel 112. As shown, the guide assemblies 1310a,b can function to support the disc 1306 as it moves in the vertical direction 1308 between the open configuration 1304 and the closed configuration 1402. The disc 1306 can remain aligned within the track 120 of the guide assemblies 1310a,b to provide a fluid-tight seal in the closed configuration 1402 and reduce friction on the disc 1306 as it moves between the open configuration 1304 and the closed configuration 1402. When the disc 1306 is in the closed configuration 1402, the seat 1404 can form a fluid-tight seal along the disc 1306.

FIGS. 15 and 16 show a horizontal gate valve 1500 oriented horizontally in an open configuration 1502 and a closed configuration 1602, respectively. That is, FIG. 15 shows the horizontal gate valve 1500 in the open configuration 1502, and FIG. 16 shows the horizontal gate valve 1500 in the closed configuration 1602. In various aspects, gate valve 1500 can be the same as or similar to valve 100, installed in the horizontal orientation.

A gate or disc 1504 can be coupled to a horizontal stem 1506 in the open configuration 1502 (FIG. 15) and the closed configuration 1602 (FIG. 16). FIG. 16 shows (in an exaggerated depiction) the tendency for the disc 1504 to shift vertically by a vertical offset 1604 when moved from the open configuration 1502 to the closed configuration 1602 due to the weight of the disk 1504. The use of a pair of opposed guide assemblies 1510a,b can facilitate retention of the disc 1504 within the track 120 (FIG. 1) as it moves along a horizontal direction 1512 (e.g., from the open configuration 1502 of FIG. 15 to the closed configuration 1602 of FIG. 16 and vice versa). That is, by providing the track 120 with the adjustment plate 702 (FIG. 7) and/or base plate 704 (FIG. 7) partially captured within the track 120, an operator can adjust the support of the horizontal disc 1504 and reduce and/or eliminate the vertical offset 1604 experienced by the disc 1504 in the closed configuration 1602. The reduction and/or elimination of the vertical offset 1604 can also reduce and/or eliminate bending in the horizontal stem 1506 and friction exerted on the disc 1504 when it is moved from the open configuration 1502 to the closed configuration 1602 and back. As a result of the lowered friction on disc 1504 and/or bending on the horizontal stem 1506, an operator can apply a reduced torque on the stem 1506 to open and/or close the valve 1500. Similarly, an actuator can be used with lessened power requirements since the disc 1504 can be supported in the vertical direction 1514 and supported as it moves back and forth between the open configuration 1502 and the closed configuration 1602.

The use of the track 120, adjustment plate 702, and/or base plate 704 can reduce the vertical offset 1604 experienced by the disc 1504 in the closed configuration 1602. This can reduce the friction on disc 1504 and therefore enhance the feasibility of coupling an actuator to the disc 1504 in the horizontal direction 1512. The reduced friction can also result in reduced wear and tear and increased longevity for the components in horizontal gate valve 1500. In some aspects, because the vertical offset 1604 can be reduced in the horizontal closed configuration 1602, the seal formed by a seat 1404 of the horizontal gate valve 1500 can be enhanced to provide a fluid-tight seal in the closed configuration 1602.

The description is provided as an enabling teaching of the present devices, systems, and/or methods in their best, currently known aspect. To this end, those skilled in the relevant art will recognize and appreciate that many changes can be made to the various aspects described herein, while still obtaining the beneficial results of the present disclosure. It will also be apparent that some of the desired benefits of the present disclosure can be obtained by selecting some of the features of the present disclosure without utilizing other features. Accordingly, those who work in the art will recognize that many modifications and adaptations to the present disclosure are possible and can even be desirable in certain circumstances and are a part of the present disclosure. Thus, the following description is provided as illustrative of the principles of the present disclosure and not in limitation thereof.

As used throughout, the singular forms “a,” “an” and “the” include plural referents unless the context clearly dictates otherwise. Thus, for example, reference to a quantity of one of a particular element can comprise two or more such elements unless the context indicates otherwise. In addition, any of the elements described herein can be a first such element, a second such element, and so forth (e.g., a first widget and a second widget, even if only a “widget” is referenced).

Ranges can be expressed herein as from “about” one particular value, and/or to “about” another particular value. When such a range is expressed, another aspect comprises from the one particular value and/or to the other particular value. Similarly, when values are expressed as approximations, by use of the antecedent “about” or “substantially,” it will be understood that the particular value forms another aspect. It will be further understood that the endpoints of each of the ranges are significant both in relation to the other endpoint, and independently of the other endpoint.

For purposes of the current disclosure, a material property or dimension measuring about X or substantially X on a particular measurement scale measures within a range between X plus an industry-standard upper tolerance for the specified measurement and X minus an industry-standard lower tolerance for the specified measurement. Because tolerances can vary between different materials, processes and between different models, the tolerance for a particular measurement of a particular component can fall within a range of tolerances.

As used herein, the terms “optional” or “optionally” mean that the subsequently described event or circumstance may or may not occur, and that the description comprises instances where said event or circumstance occurs and instances where it does not.

The word “or” as used herein means any one member of a particular list and also comprises any combination of members of that list. The phrase “at least one of A and B” as used herein means “only A, only B, or both A and B”; while the phrase “one of A and B” means “A or B.”

As used herein, unless the context clearly dictates otherwise, the term “monolithic” in the description of a component means that the component is formed as a singular component that constitutes a single material without joints or seams.

To simplify the description of various elements disclosed herein, the conventions of “left,” “right,” “front,” “rear,” “top,” “bottom,” “upper,” “lower,” “inside,” “outside,” “inboard,” “outboard,” “horizontal,” and/or “vertical” may be referenced. Unless stated otherwise, “front” describes that end of the seat nearest to and occupied by a user of a seat; “rear” is that end of the seat that is opposite or distal the front; “left” is that which is to the left of or facing left from a person sitting in the seat and facing towards the front; and “right” is that which is to the right of or facing right from that same person while sitting in the seat and facing towards the front. “Horizontal” or “horizontal orientation” describes that which is in a plane extending from left to right and aligned with the horizon. “Vertical” or “vertical orientation” describes that which is in a plane that is angled at 90 degrees to the horizontal.

One should note that conditional language, such as, among others, “can,” “could,” “might,” or “may,” unless specifically stated otherwise, or otherwise understood within the context as used, is generally intended to convey that certain aspects include, while other aspects do not include, certain features, elements and/or steps. Thus, such conditional language is not generally intended to imply that features, elements and/or steps are in any way required for one or more particular aspects or that one or more particular aspects necessarily comprise logic for deciding, with or without user input or prompting, whether these features, elements and/or steps are included or are to be performed in any particular aspect.

It should be emphasized that the above-described aspects are merely possible examples of implementations, merely set forth for a clear understanding of the principles of the present disclosure. Many variations and modifications may be made to the above-described aspect(s) without departing substantially from the spirit and principles of the present disclosure. Further, the scope of the present disclosure is intended to cover any and all combinations and sub-combinations of all elements, features, and aspects discussed above. All such modifications and variations are intended to be included herein within the scope of the present disclosure, and all possible claims to individual aspects or combinations of elements or steps are intended to be supported by the present disclosure.

That which is claimed is:

1. A valve comprising:
a valve body defining a valve port and a guide channel;
a gate configured to slide along the guide channel in the valve body between an open configuration and a closed configuration;
a guide assembly comprising a track mounted in the guide channel and configured to couple a portion of the gate in the guide channel, the track comprising an adjustment plate coupled to the track; and
a seat that engages and seals the gate in the closed configuration.

2. The valve of claim 1, wherein the guide assembly is a first guide assembly, and the guide channel is a first guide channel, further comprising a second guide channel in the valve body oriented opposite from the first guide channel, wherein a second guide assembly comprising a track is mounted in the second guide channel, and wherein the first guide assembly is oriented opposite from the second guide assembly.

3. The valve of claim 1, further comprising a stem coupled to the gate and configured to attach to an actuator, wherein the adjustment plate extends in a horizontal direction and supports the gate when the gate moves from the open configuration to the closed configuration.

4. The valve of claim 1, further comprising a sealed bonnet coupled to the valve body and capturing a stem coupled to the gate, wherein the sealed bonnet receives the gate in the open configuration and is configured to maintain a fluid-tight seal between the gate and the valve body in the closed configuration.

5. The valve of claim 1, wherein the guide assembly further comprises fasteners that couple the adjustment plate to the track, and wherein the fasteners are evenly spaced along a length of the adjustment plate.

6. The valve of claim 1, further comprising a base plate interposed between and coupled to the track and the adjustment plate.

7. The valve of claim 6, wherein primary fasteners secure the base plate to the track and secondary fasteners secure the base plate to the adjustment plate, wherein a cured resin couples the track to the guide channel.

8. The valve of claim 6, wherein the track, the base plate, and the adjustment plate each comprise stainless steel.

9. The valve of claim 1, wherein the track is a U-shaped rail within the guide channel, the U-shaped rail comprising a transverse web interposed between two lateral flanges, a portion of the gate being captured between the two lateral flanges of the U-shaped rail, and a base plate and the adjustment plate are coupled to the transverse web of the U-shaped rail.

10. The valve of claim 9, wherein each lateral flange extends from the transverse web defining a length, and wherein a first length at a first side of the lateral flange is less than a second length at a second side of the lateral flange and a tapered portion is interposed between the first side and the second side of the lateral flange.

11. The valve of claim 9, wherein a thickness of the transverse web is equal to or greater than a thickness of the two lateral flanges.

12. The valve of claim 1, further comprising a guide cap coupled to the gate and configured to slidably seal the gate with the adjustment plate of the track.

13. The valve of claim 12, wherein the guide cap comprises securing bolts and the gate comprises a fastening slot configured to receive the securing bolts to couple the guide cap to the gate.

14. A method of manufacturing a valve comprising:
fitting a guide assembly comprising a track within a guide channel of a valve body, the track installed within the guide channel configured to support a gate; and
coupling an adjustment plate of the guide assembly to the track to adjust a thickness of a transverse section of the guide assembly.

15. The method of claim 14, wherein the guide assembly is a first guide assembly, and the guide channel is a first guide channel, the method further comprising fitting a second guide assembly comprising a track within the second guide channel of the valve body, the second guide channel in the valve body oriented opposite from the first guide channel, and the second guide assembly is oriented opposite the first guide assembly.

16. The method of claim 14, further comprising installing a stem coupled to the gate in a horizontal orientation, wherein movement of the gate between an open configuration and a closed configuration translates the gate in a horizontal direction.

17. The method of claim 14, further comprising a stem coupled to the gate, the stem configured to couple to an actuator to move the gate between an open configuration and a closed configuration.

18. The method of claim 14, further comprising injecting a resin between the track and the guide, coupling the adjustment plate with the resin and an adjustment bolt, and curing the resin.

19. The method of claim 18, wherein the resin is a polymer epoxy resin and curing the resin further comprises thermosetting the polymer epoxy resin.

20. The method of claim 14, further comprising installing a guide cap on an end of the gate.

21. The method of claim 20, wherein the guide cap comprises bronze, and the gate is rubber encapsulated cast iron and the gate and the guide assembly each comprise steel.

22. The method of claim 14, further comprising coupling a base plate of the guide assembly to a web of the track, the base plate interposed between the web and the adjustment plate.

23. The method of claim 22, wherein the adjustment plate and the base plate comprise steel, and further comprising machining the adjustment plate before coupling the adjustment plate to the base plate.

24. The method of claim 22, wherein the base plate is connected directly to the web of the track with a plurality of primary fasteners, and the adjustment plate is connected directly to the base plate with a plurality of secondary fasteners.

25. The method of claim 22, wherein the adjustment plate and the base plate comprise stainless steel.
